(19) United States
(12) Patent Application Publication
(10) Pub. No.: US 2025/0172673 A1
(43) Pub. Date: May 29, 2025

(54) SINGLE PHOTON AVALANCHE DIODE-BASED LIDAR SYSTEMS AND METHODS

(71) Applicant: HUAWEI TECHNOLOGIES CO., LTD., Shenzhen (CN)

(72) Inventors: Ali Ahmed Ali MASSOUD, Kanata (CA); Haitao SUN, Kanata (CA); Zhiping JIANG, Kanata (CA); Hongbiao GAO, Shenzhen (CN)

(21) Appl. No.: 19/036,613

(22) Filed: Jan. 24, 2025

Related U.S. Application Data
(63) Continuation of application No. PCT/CN2022/136117, filed on Dec. 2, 2022.

(51) Int. Cl. G01S 7/486; G01S 7/481; G01S 7/497; G01S 17/10

(52) U.S. Cl. CPC G01S 7/4868; G01S 7/4816; G01S 7/497; G01S 17/10

(57) ABSTRACT

The disclosed LiDAR systems and methods are for object detection. The LiDAR method comprising: i) transmitting a light signal x(t) towards a region of interest (ROI); ii) receiving a reflected light signal and ambient noise signal, the reflected light signal including reflected light pulses reflected from at least one object in the ROI and the ambient noise signal including light signals that are not generated by the light source; iii) detecting one or more photons in the reflected light signal and/or the ambient noise signal and generating a SPAD output signal; iv) converting the SPAD output signal to a digital signal; v) determining a location of the at least one object based on the digital signal; and vi) varying a diameter of an opening defined by the tunable aperture in accordance with the ambient noise signal and operational parameters associated with the LIDAR system.

### CROSS REFERENCE TO RELATED APPLICATIONS

This application claims priority to PCT International Application No. PCT/CN2022/136117, filed on Jun. 6, 2024, in which the disclosures therein are expressly incorporated by reference in their entireties.

### TECHNICAL FIELD

The present disclosure generally relates to the field of LIDAR systems and, in particular, to Single Photon Avalanche Diode (SPAD)-based LIDAR systems and methods.

### BACKGROUND

Typically, light imaging detection and ranging (LIDAR) systems comprise a receiver configured to process the light signals. These light signals are transmitted by a transmitter included in the LIDAR system. The interaction between an object and the transmitted light signal produces a reflected signal and the receiver is configured to receive and process the reflected signals to determine a location of the objects.

Various conventional receivers rely on Single Photon Avalanche Diode (SPAD). Generally, a SPAD-based receiver is employed in a variety of applications, such as low-light detection applications, time-of-flight (TOF) applications, and time correlated single photon counting (TCSPC) applications.

A SPAD-based receiver typically includes a photosensitive region that is configured to detect low levels of light (down to a single photon) and generate a corresponding output signal. When a photon impinging on the SPAD-based receiver is part of a reflection from the object of an emitted light pulse, the output signal can be used to estimate the arrival time of the photon at the SPAD after emission of the light pulse.

It has been observed, however, that the SPAD-based receivers receive photons from both the reflected light signals and ambient noise signals. In bright environments with high ambient noise, the SPAD-based receiver may not be able to accurately detect the photons of laser pulse of 2-5 ns duration, as ambient noise signals may distort the TCSPC and reduces the signal to noise ratio (SNR).

With this said, there is an interest in developing more accurate and efficient SPAD-based LIDAR systems and methods.

### SUMMARY

The embodiments of the present disclosure have been developed based on developers' appreciation of the limitations associated with the prior art. By way of example, various conventional techniques, rely on Silicon Photo-Multiplier (SiPM) instead of using a single SPAD. The SiPM consists of an array of SPADs to receive more than one photon simultaneously. Such conventional techniques are hard to implement in many practical environments, as the SiPM-based techniques are more complicated to implement based on larger spatial areas and readout circuitry.

Another conventional technique is referred to as time-gating for SPAD-based LIDAR system to improve the SNR. The disadvantage of the time-gating based LIDAR systems is that it drastically reduces the actual detection efficiency of the measurements, therefore, progressive scanning requires long measurement times regardless of the background conditions. Using the same pulse rate leads to a significant reduction in the dynamic range.

With this said, the developers of the present disclosure have devised Single Photon Avalanche Diode (SPAD)-based LIDAR systems and methods that rely on a tunable aperture. The tunable aperture defines an opening. A diameter of the opening is variable and is varied in accordance with the ambient noise signal z(t) and operational parameters associated with the LIDAR system.

In accordance with a first broad aspect of the present disclosure, there is provided a LIDAR system comprising: a transmitter including: a light source configured to transmit a light signal x(t) towards a region of interest (ROI), the light signal x(t) includes one or more light pulses; a receiver comprising: a tunable aperture configured to receive a reflected light signal y(t) and an ambient noise signal z(t), the reflected light signal y(t) includes reflected light pulses reflected from at least one object in the ROI and the ambient noise signal z(t) includes light signals that are not generated by the light source; a single photon avalanche photodiode (SPAD) configured to detect one or more photons in the reflected light signal y(t) and/or the ambient noise signal z(t) and generate a SPAD output signal; a time-to-digital convertor (TDC) configured to convert the SPAD output signal to a digital signal; and a controller configured to determine a location of the at least one object based on the digital signal; wherein, the tunable aperture defines an opening and a diameter of the opening is varied, by the controller, in accordance with the ambient noise signal z(t) and operational parameters associated with the LIDAR system.

In accordance with any embodiments of the present disclosure, the controller is further configured to: determine a change in solar power density of the ambient noise signal z(t) during a time gap between a transmission of two light pulses included in the light signal x(t), compare the change in the solar power density with a predefined threshold, and in the event that the change in the solar power density is above the predefined threshold, compute a required change in the diameter of the opening in accordance with the change in the solar power density and the operational parameters, and change the diameter of the opening in accordance with the required change in the diameter.

In accordance with any embodiments of the present disclosure, the controller determines the change in solar power density as: β_{amb}=∫_{λ-Δλ}^{λ+Δλ}ζₛᵤₙ(λ′)dμ′ where ζₛᵤₙ(λ′) is solar spectral irradiance, λ is an operational wavelength, and ±Δλ is an operational bandwidth of the LIDAR system.

In accordance with any embodiments of the present disclosure, the controller computes the required change in the diameter as:

$${D}_{lens}^{opt} = \sqrt{\frac{1}{\frac{{β}_{amb}}{hv} tan ( \frac{{AoV}_{x}}{2} ) tan ( \frac{{AoV}_{y}}{2} ) PDE {τ}_{dead}}}$$

where h is a Planck constant, v is an operating frequency, Aovₓ & AoV_{y} are instant Field of View in x and y directions, PDE is a photon detection efficiency, and τ_{dead} is a SPAD deadtime.

In accordance with any embodiments of the present disclosure, in the event the required change in the diameter is greater than a maximum value of the diameter, the controller is configured to change the diameter to the maximum value.

In accordance with any embodiments of the present disclosure, the operational parameters include instant field of view in x and y directions, photon detection efficiency, and SPAD deadtime.

In accordance with any embodiments of the present disclosure, an operational range of the dead time is between 1 ns to 1 μs.

In accordance with any embodiments of the present disclosure, an operational range of the diameter is 1 to 12 mm.

In accordance with any embodiments of the present disclosure, the LIDAR system further comprises an aperture holder configured to hold the tunable aperture.

In accordance with a second broad aspect of the present disclosure, there is provided an optical receiver comprising: a tunable aperture configured to receive a reflected light signal y(t) and an ambient noise signal z(t), the reflected light signal y(t) includes reflected light pulses reflected from at least one object in the ROI and the ambient noise signal z(t) includes light signals that are not generated by a light source, wherein, the tunable aperture defines an opening and a diameter of the opening is varied, by a controller, in accordance with the ambient noise signal z(t) and operational parameters associated with a LIDAR system.

In accordance with a third broad aspect of the present disclosure, there is provided a LIDAR method comprising: transmitting, by a light source, a light signal x(t) towards a region of interest (ROI), the light signal x(t) including one or more light pulses; receiving, by a tunable aperture, a reflected light signal y(t) and an ambient noise signal z(t), the reflected light signal y(t) including reflected light pulses reflected from at least one object in the ROI and the ambient noise signal z(t) including light signals that are not generated by the light source; detecting, by a single photon avalanche photodiode (SPAD), one or more photons in the reflected light signal y(t) and/or the ambient noise signal z(t) and generating a SPAD output signal; converting, by a time-to-digital convertor (TDC), the SPAD output signal to a digital signal; and determining, by a controller, a location of the at least one object based on the digital signal; varying, by the controller, a diameter of an opening defined by the tunable aperture in accordance with the ambient noise signal z(t) and operational parameters associated with a LIDAR system.

In accordance with any embodiments of the present disclosure, the method further comprises determining, by the controller, a change in solar power density of the ambient noise signal z(t) during a time gap between a transmission of two light pulses included in the light signal x(t), comparing, by the controller, the change in the solar power density with a predefined threshold, and in the event that the change in the solar power density is above the predefined threshold, computing, by the controller, a required change in the diameter of the opening in accordance with the change in the solar power density and the operational parameters, and changing, by the controller, the diameter of the opening in accordance with the required change in the diameter.

In accordance with any embodiments of the present disclosure, the change in solar power density is determined as: β_{amb}=∫_{λ-Δλ}^{λ+Δλ}ζₛᵤₙ(λ′)dμ′ where ζₛᵤₙ(λ′) is solar spectral irradiance, λis an operational wavelength, and +Δλ is an operational bandwidth of the LIDAR system.

In accordance with any embodiments of the present disclosure, the required change in the diameter is computed as:

$${D}_{lens}^{opt} = \sqrt{\frac{1}{\frac{{β}_{amb}}{hv} tan ( \frac{{AoV}_{x}}{2} ) tan ( \frac{{AoV}_{y}}{2} ) PDE {τ}_{dead}}}$$

where h is the Planck constant, v is an operating frequency, Aovₓ & AoV_{y} are instant Field of View in x and y directions, PDE is a photon detection efficiency, and τ_{dead} is a SPAD deadtime.

In accordance with any embodiments of the present disclosure, in the event the required change in the diameter is greater than a maximum value of the diameter, changing the diameter to the maximum value.

In accordance with any embodiments of the present disclosure, the operational parameters include instant field of view in x and y directions, photon detection efficiency, and SPAD deadtime.

### BRIEF DESCRIPTION OF THE DRAWINGS

The features and advantages of the present disclosure will become apparent from the following detailed description, taken in combination with the appended drawings, in which:

FIG. 1 (Prior Art) Silicon Photo-Multiplier (SiPM)-based conventional LIDAR system;

FIG. 2 (Prior Art) Time-gating based conventional LIDAR system;

FIG. 3 depicts a high-level functional block diagram of a Single Photon Avalanche Diode (SPAD)-based LIDAR system directed to detect an object, in accordance with various non-limiting embodiments of the present disclosure;

FIG. 4 illustrates a representative architecture of a receiver, in accordance with various non-liming embodiments of the present disclosure; and

FIG. 5 illustrates a flowchart of a process for determining a location of an object in the ROI, in accordance with various embodiments of the present disclosure.

It is to be understood that throughout the appended drawings and corresponding descriptions, like features are identified by like reference characters. Furthermore, it is also to be understood that the drawings and ensuing descriptions are intended for illustrative purposes only and that such disclosures are not intended to limit the scope of the claims.

### DETAILED DESCRIPTION

The instant disclosure is directed to address at least some of the deficiencies of the current technology. In particular, the instant disclosure describes Single Photon Avalanche Diode (SPAD)-based LIDAR systems and methods.

Unless otherwise defined or indicated by context, all technical and scientific terms used herein have the same meaning as commonly understood by one of ordinary skill in the art to which the described embodiments appertain.

Various representative embodiments of the described technology will be described more fully hereinafter with reference to the accompanying drawings, in which representative embodiments are shown. The present technology concept may, however, be embodied in many different forms and should not be construed as limited to the representative embodiments set forth herein. Rather, these representative embodiments are provided so that the disclosure will be thorough and complete, and will fully convey the scope of the present technology to those skilled in the art. In the drawings, the sizes and relative sizes of layers and regions may be exaggerated for clarity.

It will be understood that, although the terms first, second, third, etc. may be used herein to describe various elements, these elements should not be limited by these terms. These terms are used to distinguish one element from another. Thus, a first element discussed below could be termed a second element without departing from the teachings of the present technology. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is only intended to describe particular representative embodiments and is not intended to be limiting of the present technology. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “controller”, “processor”, “pre-processor”, or “processing unit”, may be provided through the use of dedicated hardware as well as hardware capable of executing software in association with appropriate software and according to the methods described herein. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

In the context of the present specification, unless provided expressly otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first processor” and “third processor” is not intended to imply any particular order, type, chronology, hierarchy or ranking (for example) of/between the processor, nor is their use (by itself) intended to imply that any “second processor” must necessarily exist in any given situation. Further, as is discussed herein in other contexts, reference to a “first” element and a “second” element does not preclude the two elements from being the same actual real-world element. Thus, for example, in some instances, a “first” processor and a “second” processor may be the same software and/or hardware, in other cases they may be different software and/or hardware.

In the context of the present specification, when an element is referred to as being “associated with” another element, in certain embodiments, the two elements can be directly or indirectly linked, related, connected, coupled, the second element employs the first element, or the like without limiting the scope of the present disclosure.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Software modules, or simply modules or units which are implied to be software, may be represented herein as any combination of flowchart elements or other elements indicating performance of process steps and/or textual description. Such modules may be executed by hardware that is expressly or implicitly shown, the hardware being adapted to (made to, designed to, or configured to) execute the modules. Moreover, it should be understood that module may include for example, but without being limitative, computer program logic, computer program instructions, software, stack, firmware, hardware circuitry or a combination thereof which provides the required capabilities.

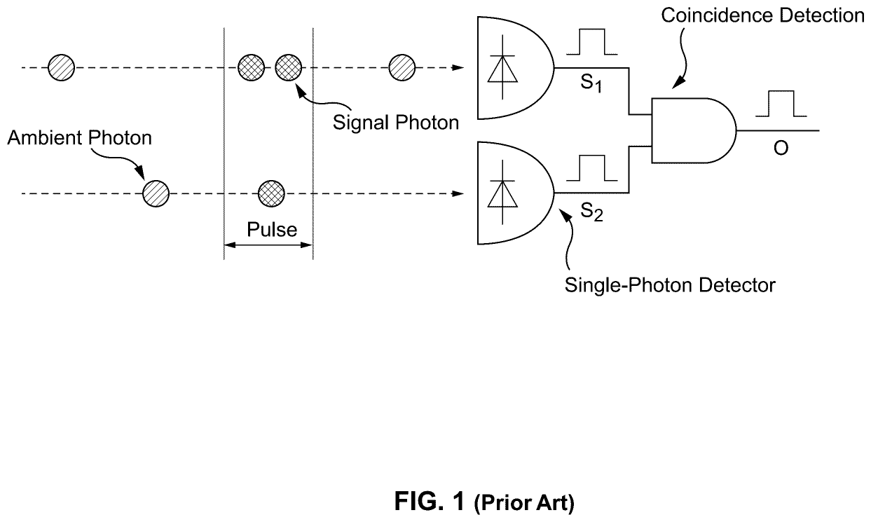

With these fundamentals in place, the instant disclosure is directed to address at least some of the deficiencies of the current technology. By way of example, various conventional techniques rely on Silicon Photo-Multiplier (SiPM) instead of using a single SPAD. The SiPM consists of an array of SPADs therefore the SiPM can receive more than one photon simultaneously. Such conventional techniques apply photon coincidence technique to improve the TCSPC and SNR. First, the ambient noise level is estimated during the idle time (i.e., no emitted pulses). A threshold proportional to noise level (as shown in FIG. 1 (Prior Art)) is then applied to ideally construct the TCSPC (Histogram) from the laser pulse photons only. Even though, the SiPM-based conventional techniques have certain advantages, such SiPM-based techniques are hard to implement in many practical environments, as the SiPM-based techniques are more complicated to implement based on larger spatial areas and readout circuitry.

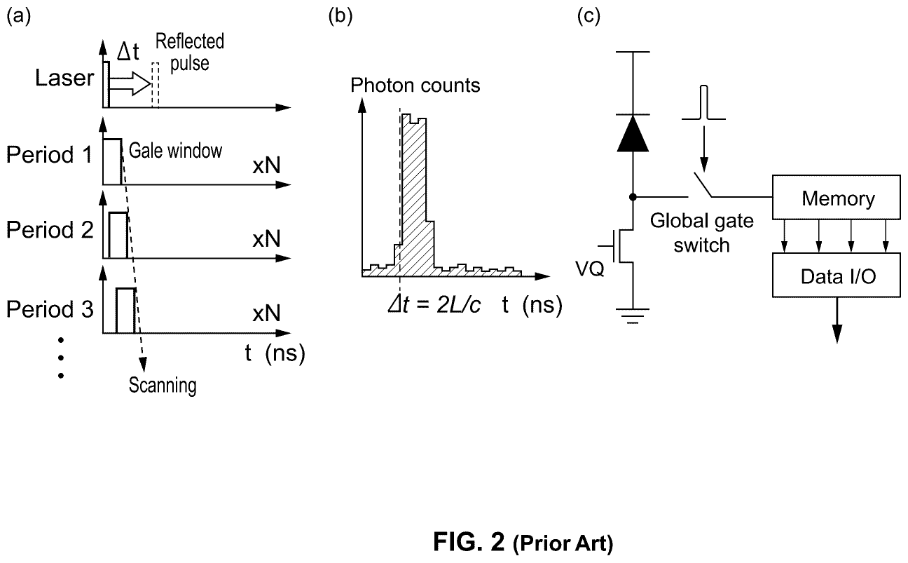

Another conventional technique is referred to as time-gating for SPAD-based LIDAR system to improve the SNR. The time-gating based conventional LIDAR systems involve consecutive frames with a finely shifted gate window, each of which perform photon counting integrated over N sub-frames as depicted in FIG. 2 (Prior Art).

The time-gating based conventional LIDAR systems reduce the distortion due to background illumination. The time-gating based conventional LIDAR systems count only photons returning within the selected gate window and perform time filtering of the incoming light signals. The disadvantage of the time-gating based LIDAR systems is that it drastically reduces the actual detection efficiency of the measurements, therefore, progressive scanning requires long measurement times regardless of the background conditions. Using the same pulse rate leads to a significant reduction in the dynamic range.

With this said, there is an interest in developing more efficient SPAD-based LIDAR systems and methods.

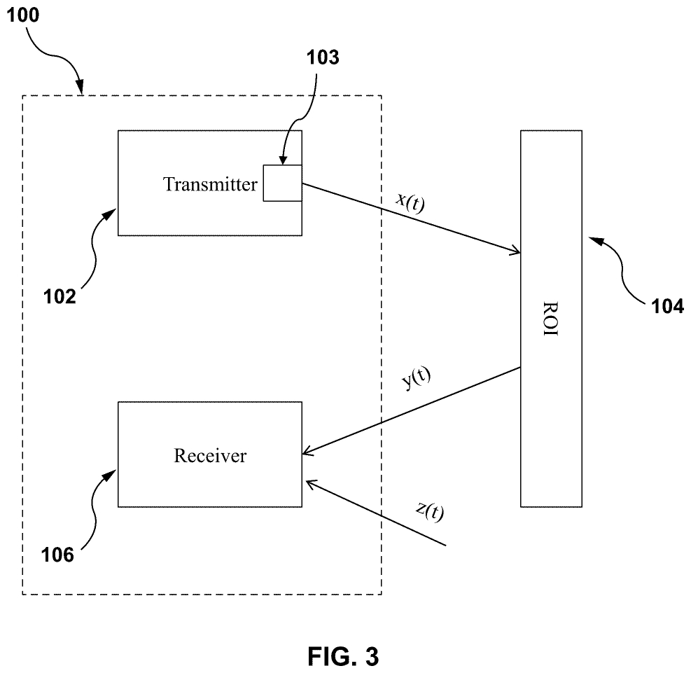

FIG. 3 depicts a high-level functional block diagram of a SPAD-based LIDAR system 100, directed to detect an object, in accordance with the various non-limiting embodiments presented by the instant disclosure. As shown, the SPAD-based LIDAR system 100 may employ a transmitter 102 and a receiver 106. It will be understood that the SPAD-based LIDAR system 100 may include other elements but such elements have not been illustrated in FIG. 3 for the purpose of tractability and simplicity.

The transmitter 102 may include a light source 103, for example, laser configured to emit light signals including one or more light pulses. The light source 103 may be a laser such as a solid-state laser, laser diode, a high-power laser, or an alternative light source 103 such as, a light emitting diode (LED)-based light source 103. In some (non-limiting) examples, the light source 103 may be provided by Fabry-Perot laser diodes, a quantum well laser, a distributed Bragg reflector (DBR) laser, a distributed feedback (DFB) laser, and/or a vertical-cavity surface-emitting laser (VCSEL).

The light source 103 may include a laser diode configured to emit light at a wavelength between about 650 nm and 1150 nm. Alternatively, the light source 103 may include a laser diode configured to emit light beams at a wavelength between about 800 nm and about 1000 nm, between about 850 nm and about 950 nm, between about 1300 nm and about 1600 nm or in any other suitable range known in the art for near-IR detection and ranging. Unless indicated otherwise, the term “about” with regard to a numeric value is defined as a variance of up to 10% with respect to the stated value.

The transmitter 102 may be configured to transmit light signal x(t) towards a region of interest (ROI) 104. The transmitted light signal x(t) may include one or more relevant operating parameters, such as: signal duration, signal angular dispersion, wavelength, instantaneous power, photon density at different distances from the light source 103, average power, signal power intensity, signal width, signal repetition rate, signal sequence, pulse duty cycle, wavelength, or phase, etc. The transmitted light signal x(t) may be unpolarized or randomly polarized, may have no specific or fixed polarization (e.g., the polarization may vary with time), or may have a particular polarization (e.g., linear polarization, elliptical polarization, or circular polarization).

It is contemplated that the ROI 104 area may have different objects located at some distance from the SPAD-based LIDAR system 100. At least some of the transmitted light signal x(t) may be reflected from one or more objects in the ROI 104. By reflected light, it is meant that at least a portion of the transmitted light signal x(t) reflects or bounces off the one or more objects within the ROI 104. The transmitted light signal x(t) may have one or more relevant parameters of interest such as: time-of-flight (i.e., time from emission until detection), instantaneous power (e.g., power signature), average power across entire return pulse, and photon distribution/signal over return pulse period, etc.

With this said, a reflected light signal y(t) may be received by the receiver 106. The reflected light signal y(t) may include reflected light pulses reflected from at least one object in the ROI 104. The receiver 106 may be configured to process the reflected light signal y(t) to determine and/or detect one or more objects in the ROI 104 and the associated distance from the SPAD-based LIDAR system 100. It is contemplated that the receiver 106 may be configured to analyze one or more characteristics of the reflected light signal y(t) to determine one or more objects such as the distance downrange from the SPAD-based LIDAR system 100. In addition to the reflected light signal y(t), the receiver 106 may also receive ambient noise signal z(t). The ambient noise signal z(t) may be the light signals received from the environment/surroundings and are not generated by the light source 103.

By way of example, the receiver 106 may be configured to determine a “time-of-flight” value from the reflected light signal y(t) based on timing information associated with: (i) when the light signal x(t) was emitted by the transmitter 102; and (ii) when the reflected light signal y(t) was detected or received by the receiver 106. For example, assuming that the SPAD-based LIDAR system 100 determines a time-of-light value “T” representing, in a sense, a “round-trip” time for the transmitted light signal x(t) to travel from the SPAD-based LIDAR system 100 to the object and back to the SPAD-based LIDAR system 100. As a result, the receiver 106 may be configured to determine the distance in accordance with the following equation:

$$R = \frac{c * T}{2} \qquad ( 1 )$$

wherein R is the distance, T is the time-of-flight value, and c is the speed of light (approximately 3.0×10⁸ m/s).

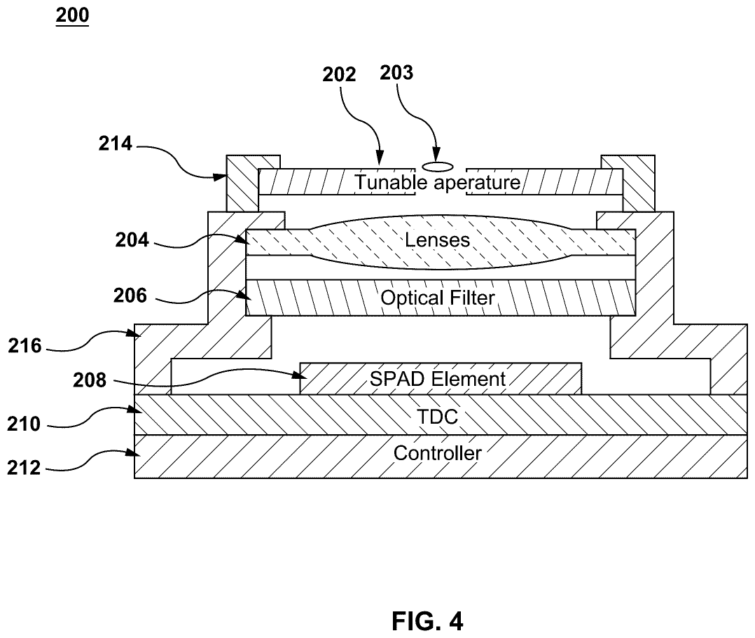

FIG. 4 illustrates a representative architecture 200 of the receiver 106, in accordance with various non-liming embodiments of the present disclosure. As shown, the receiver 106 may include a tunable aperture 202, one or more lenses 204, an optical filter 206, a SPAD element 208, a time-to-digital convertor (TDC) 210, and a controller 212. In certain non-limiting embodiments, the tunable aperture 202 may be included in an aperture holder 214. Also, the one or more lenses 204, the optical filter 206, and the SPAD element 208 may be included in a LIDAR barrel 216. It is to be noted that the architecture 200 may include other components, however such components have been omitted from FIG. 4 for the purpose of simplicity.

The tunable aperture 202 may have a tunable opening configured to the receive the light signal y(t) and the ambient noise signal z(t). In some examples, a variable diameter 203 of the opening of the tunable aperture 202 may be in the range of 1-12 mm. The variable diameter 203 of the opening may be varied by the controller 212. How the diameter 203 is varied will be discussed later in the disclosure.

Without limiting the scope of the present disclosure, in one example, the tunable aperture 202 may be based on an adaptive liquid iris-based on electro-wetting. The liquid iris may include opaque liquid for absorbing light and a transparent oil for transmitting light on two parallel plates with patterned indium titanium oxide (ITO). In this example, the tunable aperture 202 may be implemented as smart liquid ring allowing planar microfabrication processes. It will be appreciated that the adaptive liquid Iris-based tunable aperture 202 may be one example and the tunable aperture 202 may be implemented in any suitable manner.

The one or more lenses 204 may be located between the tunable aperture 202 and the optical filter 206. How the one or more lenses 204 have been implemented should not limit the scope of present disclosure. The one or more lenses 204 may be configured to receive the received light signal y(t) and the ambient noise signal z(t) from the tunable aperture 202.

The one or more lenses 204 may forward the light signal y(t) and the ambient noise signal z(t) to the optical filter 206. The optical filter 206 may filter the received light signal y(t) and the ambient noise signal z(t) outside a given a range. The optical filter 206 may have a bandwidth of ±15 nm.

The filtered signals from the one or more lenses 204 may be forwarded to the SPAD element 208. The SPAD element 208 may be configured to detect one or more photons in the reflected light signal y(t) and/or the ambient noise signal z(t) and generate a SPAD output signal.

It is to be noted that the SPAD element 208 may be a solid-state photodetector. The SPAD element 208 may be based around a semi-conductor p-n junction that can be illuminated with ionizing radiation such as a wide portion of the electromagnetic spectrum from ultraviolet (UV) through the visible wavelengths and into the infrared (IR).

In the SPAD element 208, a reverse bias is quite high such that a phenomenon known as impact ionization may occur which may be able to cause an avalanche current to develop. The SPAD element 208 may be able to detect single or multiple photons providing short duration trigger pulses, also referred to as SPAD output signal, that may be counted. Additionally, the SPAD element 208 may be used to obtain the time of arrival of the incident photon due to the high speed that the avalanche builds up.

The SPAD element 208 may forward the SPAD output signal to the TDC 210. The TDC 210 may be configured to convert the SPAD output signal to a digital signal. The digital signals may be represented as histograms. The TDC 210 may be a device for recognizing events and providing a digital representation of the time the events have occurred. By way of example, the TDC 210 might output the time of arrival for each incoming pulse in the SPAD output signal. The TDC 210 may provide the digital signal to the controller 212.

The controller 212 may be configured to determine a location of the at least one object in the ROI 104 based on the digital signal using equation 1.

To reduce the effect of the ambient noise signal z(t) on the time correlated single photon counting (TCSPC) and improve the signal-to-noise ratio (SNR), in various non-limiting embodiments of the present, the controller 212 may be configured to tune/vary the diameter 203 of the opening of the tunable aperture 202. The controller 212 may vary the diameter 203 in accordance with the ambient noise signal z(t) and operational parameters associated with the LIDAR system 200. The operational parameters associated with the LIDAR system 200 may include instant field of view in x and y directions, photon detection efficiency, and SPAD deadtime.

In order to determine a change in the diameter 203, the controller 212 may be configured to determine a change in solar power density β_{amb} of the ambient noise signal z(t). The solar power density β_{amb} may represent noise estimation of the ambient noise signal z(t). The controller 212 may determine the change in the solar power density β_{amb} during a time gap between a transmission of two light pulses included in the light signal x(t). As previously noted, the light signal x(t) may include light pulses. The two light pulses in the light signal x(t) may be separated by certain time duration. In other words, two light pulses may have a time gap in between.

In certain non-limiting embodiments, the controller 212 may determine the change in the solar power density β_{amb} as:

$${β}_{amb} = {\int }_{λ - Δλ}^{λ + Δλ} {ζ}_{sun} ( {λ}^{′} ) d {λ}^{′} \qquad ( 2 )$$

where ζₛᵤₙ(λ′) is solar spectral irradiance, λ (for example, 905 nm) is an operational wavelength, and ±λ (for example, +15 nm) is an operational bandwidth of the optical filter 206 included in the LIDAR system 200. It is to be noted that the solar spectral irradiance ζₛᵤₙ(λ′) may be determined by the controller 212 in accordance with any suitable techniques. By way of example, the controller 212 may include additional sensors to determine the solar spectral irradiance ζₛᵤₙ(λ′).

The controller 212 may compare the change in the solar power density β_{amb} with a predefined threshold. In certain non-limiting embodiments, the predefined threshold may be close to zero.

In the event the change in the solar power density β_{amb} is above the predefined threshold, the controller 212 may compute a required change in the diameter 203 of the opening in accordance with the change in the solar power density and the operational parameters. In certain non-limiting embodiments, the controller 212 may determine the change the diameter 203 as:

$${D}_{aperture}^{opt} = \sqrt{\frac{1}{\frac{{β}_{amb}}{hv} tan ( \frac{{AoV}_{x}}{2} ) tan ( \frac{{AoV}_{y}}{2} ) PDE {τ}_{dead}}} \qquad ( 3 )$$

where h is the Planck constant, v is an operating frequency, AoVₓ & AoV_{y} are instant Field of View in x and y directions, PDE is a photon detection efficiency, and τ_{dead} is a SPAD deadtime. The exemplary representative values of the AoV_{y} & AoV_{y} are instant Field of View in x and y direction may be 0.2°×0.2°, PDE may be 25% and the τ_{dead} may be in the operational range of 1 ns to 1 μs.

In the event the computed change in the diameter is greater than a maximum value of the diameter 203, the controller 212 may be configured to change the diameter to the maximum possible value (for example to 12 mm).

By virtue of varying the diameter 203 in accordance with equation 3, the effect of the ambient noise signal z(t) on the TCSPC maybe significantly reduced and SNR may be significantly improved. Additionally, the SPAD-based LIDAR system 100 may be used for the short-range applications such as cellphone as well as Advanced driver-assistance systems (ADAS).

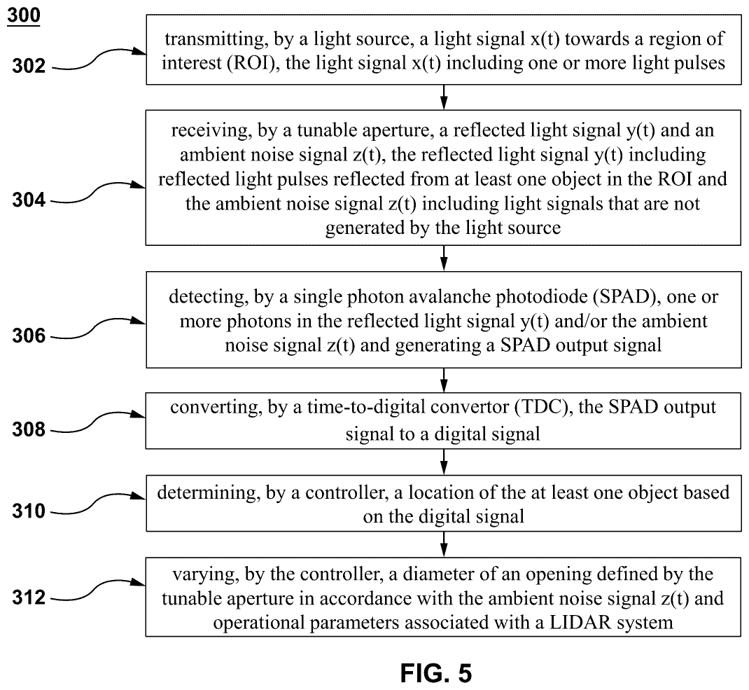

FIG. 5 illustrates a flowchart of a process 300 for determining a location of an object in the ROI, in accordance with various embodiments of the present disclosure. The process 300 commences at step 302 where a light source transmits a light signal x(t) towards a region of interest (ROI), the light signal x(t) including one or more light pulses. As previously noted, the light source 103 transmits a light signal x(t) towards the ROI 104. The light signal x(t) may include one or more light pulses.

The process 300 advances to step 304 where a tunable aperture receives a reflected light signal y(t) and an ambient noise signal z(t), the reflected light signal y(t) including reflected light pulses reflected from at least one object in the ROI and the ambient noise signal z(t) including light signals that are not generated by the light source. As noted above, the tunable aperture 202 receives the reflected light signal y(t) and the ambient noise signal z(t), the reflected light signal y(t) including the reflected light pulses reflected from at least one object in the ROI 104 and the ambient noise signal z(t) including light signals that are not generated by the light source 103.

The process 300 proceeds to step 306 where a single photon avalanche photodiode (SPAD) detects one or more photons in the reflected light signal y(t) and/or the ambient noise signal z(t) and generating a SPAD output signal. As noted above, the SPAD element 208 detects one or more photons in the reflected light signal y(t) and/or the ambient noise signal z(t) and generating a SPAD output signal.

The process 300 advances to step 308 where a time-to-digital convertor (TDC) converts the SPAD output signal to a digital signal. As discussed previously, the TDC 210 converts the SPAD output signal to a digital signal.

The process 300 moves to step 310 where a controller determines a location of the at least one object based on the digital signal. As previously noted, the controller 212 may determine a location of the objects based on the digital signal.

Finally at step 312, the controller varies a diameter of an opening defined by the tunable aperture in accordance with the ambient noise signal z(t) and operational parameters associated with a LIDAR system. As discussed above, the tunable aperture 202 defines an opening. The controller 212 varies the diameter 203 of the opening based on the ambient noise signal z(t) and operational parameters associated with the LIDAR system 100.

It is to be understood that the operations and functionality of the SPAD-based LIDAR system 100, constituent components, and associated processes may be achieved by any one or more of hardware-based, software-based, and firmware-based elements. Such operational alternatives do not, in any way, limit the scope of the present disclosure.

It will also be understood that, although the embodiments presented herein have been described with reference to specific features and structures, it is clear that various modifications and combinations may be made without departing from such disclosures. The specification and drawings are, accordingly, to be regarded simply as an illustration of the discussed implementations or embodiments and their principles as defined by the appended claims, and are contemplated to cover any and all modifications, variations, combinations or equivalents that fall within the scope of the present disclosure.

What is claimed is:

1. A LIDAR system comprising:
a transmitter including:
a light source configured to transmit a light signal x(t) towards a region of interest (ROI), the light signal x(t) includes one or more light pulses;
a receiver comprising:
a tunable aperture configured to receive a reflected light signal y(t) and an ambient noise signal z(t), the reflected light signal y(t) includes reflected light pulses reflected from at least one object in the ROI and the ambient noise signal z(t) includes light signals that are not generated by the light source;
a single photon avalanche photodiode (SPAD) configured to detect one or more photons in the reflected light signal y(t) and/or the ambient noise signal z(t) and generate a SPAD output signal;
a time-to-digital convertor (TDC) configured to convert the SPAD output signal to a digital signal; and
a controller configured to determine a location of the at least one object based on the digital signal;
wherein, the tunable aperture defines an opening and a diameter of the opening is varied, by the controller, in accordance with the ambient noise signal z(t) and operational parameters associated with the LIDAR system.

2. The LIDAR system of claim 1, wherein the controller is further configured to:
determine a change in solar power density of the ambient noise signal z(t) during a time gap between a transmission of two light pulses included in the light signal x(t),
compare the change in the solar power density with a predefined threshold, and
in the event that the change in the solar power density is above the predefined threshold,
compute a required change in the diameter of the opening in accordance with the change in the solar power density and the operational parameters, and
change the diameter of the opening in accordance with the required change in the diameter.

3. The LIDAR system of claim 2, wherein the controller determines the change in solar power density as:
$${β}_{amb} = {\int }_{λ - Δλ}^{λ + Δλ} {ζ}_{sun} ( {λ}^{′} ) d {λ}^{′}$$
where ζₛᵤₙ(λ′) is solar spectral irradiance, λ is an operational wavelength, and ±Δλ is an operational bandwidth of the LIDAR system.

4. The LIDAR system of claim 2, wherein the controller computes the required change in the diameter as:
$${D}_{lens}^{opt} = \sqrt{\frac{1}{\frac{{β}_{amb}}{hv} tan ( \frac{{AoV}_{x}}{2} ) tan ( \frac{{AoV}_{y}}{2} ) PDE {τ}_{dead}}}$$
where h is the Planck constant, v is an operating frequency, AoVₓ & AoV_{y} are instant Field of View in x and y directions, PDE is a photon detection efficiency, and τ_{dead} is a SPAD deadtime.

5. The LIDAR system of claim 4, wherein in the event the required change in the diameter is greater than a maximum value of the diameter, the controller is configured to change the diameter to the maximum value.

6. The LIDAR system of claim 2, wherein the operational parameters include instant field of view in x and y directions, photon detection efficiency, and SPAD deadtime.

7. The LIDAR system of claim 6, wherein an operational range of the dead time is between 1 ns to 1 μs.

8. The LIDAR system of claim 1, wherein an operational range of the diameter is 1 to 12 mm.

9. The LIDAR system of claim 1 further comprising an aperture holder configured to hold the tunable aperture.

10. An optical receiver comprising:
a tunable aperture configured to receive a reflected light signal y(t) and an ambient noise signal z(t), the reflected light signal y(t) includes reflected light pulses reflected from at least one object in the ROI and the ambient noise signal z(t) includes light signals that are not generated by a light source, wherein, the tunable aperture defines an opening and a diameter of the opening is varied, by a controller, in accordance with the ambient noise signal z(t) and operational parameters associated with a LIDAR system.

11. The optical receiver of 10, wherein the diameter of the opening is varied as:
$${D}_{lens}^{opt} = \sqrt{\frac{1}{\frac{{β}_{amb}}{hv} tan ( \frac{{AoV}_{x}}{2} ) tan ( \frac{{AoV}_{y}}{2} ) PDE {τ}_{dead}}}$$
where h is the Planck constant, v is an operating frequency, AoVₓ & AoV_{y} are instant Field of View in x and y directions, PDE is a photon detection efficiency, and τ_{dead} is a SPAD deadtime.

12. The optical receiver of claim 10, wherein an operational range of the diameter is 1 to 12 mm.

13. The optical receiver of claim 10 further comprising an aperture holder configured to hold the tunable aperture.

14. A LIDAR method comprising:
transmitting, by a light source, a light signal x(t) towards a region of interest (ROI), the light signal x(t) including one or more light pulses;
receiving, by a tunable aperture, a reflected light signal y(t) and an ambient noise signal z(t), the reflected light signal y(t) including reflected light pulses reflected from at least one object in the ROI and the ambient noise signal z(t) including light signals that are not generated by the light source;
detecting, by a single photon avalanche photodiode (SPAD), one or more photons in the reflected light signal y(t) and/or the ambient noise signal z(t) and generating a SPAD output signal;
converting, by a time-to-digital convertor (TDC), the SPAD output signal to a digital signal; and
determining, by a controller, a location of the at least one object based on the digital signal;
varying, by the controller, a diameter of an opening defined by the tunable aperture in accordance with the ambient noise signal z(t) and operational parameters associated with a LIDAR system.

15. The LIDAR method of claim 14 further comprising:
determining, by the controller, a change in solar power density of the ambient noise signal z(t) during a time gap between a transmission of two light pulses included in the light signal x(t),
comparing, by the controller, the change in the solar power density with a predefined threshold, and
in the event that the change in the solar power density is above the predefined threshold,
computing, by the controller, a required change in the diameter of the opening in accordance with the change in the solar power density and the operational parameters, and
changing, by the controller, the diameter of the opening in accordance with the required change in the diameter.

16. The LIDAR method of claim 15, wherein the change in solar power density is determined as:
$${β}_{amb} = {\int }_{λ - Δλ}^{λ + Δλ} {ζ}_{sun} ( {λ}^{′} ) d {λ}^{′}$$
where ζₛᵤₙ(λ′) is solar spectral irradiance, λ is an operational wavelength, and ±Δ is an operational bandwidth of the LIDAR system.

17. The LIDAR method of 16, wherein the required change in the diameter is computed as:
$${D}_{lens}^{opt} = \sqrt{\frac{1}{\frac{{β}_{amb}}{hv} tan ( \frac{{AoV}_{x}}{2} ) tan ( \frac{{AoV}_{y}}{2} ) PDE {τ}_{dead}}}$$
where h is the Planck constant, v is an operating frequency, AoVₓ & AoV_{y} are instant Field of View in x and y directions, PDE is a photon detection efficiency, and τ_{dead} is a SPAD deadtime.

18. The LIDAR method of claim 15, wherein in the event the required change in the diameter is greater than a maximum value of the diameter, changing the diameter to the maximum value.

19. The LIDAR method of claim 15, wherein the operational parameters include instant field of view in x and y directions, photon detection efficiency, and SPAD deadtime.

20. The LIDAR method of claim 14, wherein an operational range of the diameter is 1 to 12 mm.
